(19) United States
(12) Patent Application Publication
(10) Pub. No.: US 2022/0317253 A1
(43) Pub. Date: Oct. 6, 2022

(54) METHODS AND APPARATUSES FOR IMPROVED ADHESIVE BONDING IN A LiDAR SYSTEM

(71) Applicant: Beijing Voyager Technology Co., Ltd., Beijing (CN)

(72) Inventors: Anan Pan, Mountain View, CA (US); Henghui Jiang, Mountain View, CA (US); Ming-Hui Wu, Mountain View, CA (US); Youmin Wang, Mountain View, CA (US)

(21) Appl. No.: 17/221,285

(22) Filed: Apr. 2, 2021

(51) Int. Cl. G01S 7/481; G02B 27/62; B29C 65/48

(52) U.S. Cl. CPC G01S 7/4811; G02B 27/62; B29C 65/4845; B29L 2031/30

(57) ABSTRACT

Aligning a detection or transmission module with an optical lens assembly on a chassis in a LiDAR system may include a transparent mounting block, for example a glass transparent mounting block. A first portion of adhesive may be applied between the transparent mounting block and the chassis, and a second portion of adhesive may be between the transparent mounting block and the detection or transmission module. Prior to curing the portions of adhesive, the detection and/or transmission module may be optically aligned with the optical lens assembly so that a path of a laser beam emitted from a laser module of the transmission module is oriented with an optical path in the optical lens assembly to a detection sensor of the detection module. The transparent mounting block allows for visual inspection of the cured first and second portions of adhesive through the transparent mounting block.

### BACKGROUND

Modern vehicles are often equipped with sensors designed to detect objects and landscape features around the vehicle in real-time to enable technologies such as lane change assistance, collision avoidance, and autonomous driving. A commonly used sensor is a light detection and ranging (LiDAR) system.

A LiDAR system may include a light source, also referred to as a transmission module (TX module), and a light detection system, also referred to as a detection module (also referred to as a receiver (RX) module), to estimate distances to environmental features (e.g., pedestrians, vehicles, structures, plants, etc.). The emitted laser beam from the TX module is used to illuminate a target and the RX module receives the reflections from the laser beam in order for the LiDAR system to measure the time it takes for the transmitted laser beam to arrive at the target and then return to the detection module. In some LiDAR systems, the laser beam may be steered across a region of interest according to a scanning pattern to generate a “point cloud” that includes a collection of data points corresponding to target points in the region of interest. The data points in the point cloud may be dynamically and continuously updated, and may be used to estimate, for example, a distance, dimension, and location of an object relative to the LiDAR system, often with very high fidelity (e.g., within about 5 cm) due to the precision of the optical alignment of the components.

### BRIEF SUMMARY

In some embodiments, the present technology relates to a method of optically aligning a detection or transmission module with an optical lens assembly in a LiDAR system. The optical lens assembly may be coupled to a chassis, to which the detection or transmission module will also be coupled after alignment. The method may include orienting the detection or transmission module relative to the optical lens assembly to an optically aligned orientation. Optical alignment may be achieved when a path of a laser beam emitted from a laser module of the transmission module is oriented with an optical path in the optical lens assembly to a detection sensor of the detection module. The method may further include applying a first portion of adhesive between a transparent mounting block and the chassis, and applying a second portion of adhesive between the transparent mounting block and the detection or transmission module. The transparent mounting block may be translated to be adjacent to the oriented detection or transmission module. The first and second portions of adhesive may be cured in any order in order to fixedly couple the detection or transmission module relative to the chassis. The transparent mounting block may allow for visual inspection of the cured first and second portions of adhesive through the transparent mounting block.

In some embodiments, the method may be directed toward alignment of a detection module. The detection module may include a detection circuit board assembly comprising a board and the detection sensor, and a bracket. The detection circuit board assembly may be fixedly coupled to the bracket with screws. The method may further include applying the second portion of adhesive between the transparent mounting block and the bracket. In some embodiments, the method may also include the bracket including a planar portion and a tab extending away from the planar portion. The method may further include translating the transparent mounting block adjacent to the oriented detection module so that a first bonding surface of the transparent mounting block is positioned against the tab with the second portion of adhesive there between.

In some embodiments, the method may be directed toward alignment of a transmission module. The transmission module may include a transmission circuit board assembly including a board and the laser module, and a second chassis. The transmission circuit board assembly may be fixedly coupled to the second chassis with screws. Applying the second portion of adhesive includes applying the second portion of adhesive between the transparent mounting block and the second chassis. In some embodiments, the second chassis may include a central portion to which the transmission circuit board assembly is fixedly coupled, and a tab extending away from the central portion. In some embodiments, translating the transparent mounting block adjacent to the oriented transmission module comprises positioning a first bonding surface of the transparent mounting block against the tab with the second portion of adhesive there between.

In some embodiments, curing the first and second portions of adhesive in order to fixedly couple the detection or transmission module relative to the chassis may include emitting ultraviolet radiation through the transparent mounting block in order to cure the first and second portions of adhesive. In some embodiments, the transparent mounting block may be made of glass. In some embodiments, the transparent mounting block may include a rectangular prism shaped body. The rectangular prism shaped body may define a first bonding surface with a first surface roughness, and a second face opposite the first bonding surface with a second surface roughness less than the first surface roughness. The first portion of adhesive may be applied between the first bonding surface and the chassis. the first surface roughness of the first face may be defined by a plurality of grooves.

The present technology may further be direct toward a LiDAR system including a chassis, an optical lens assembly coupled to a chassis, a transparent mounting block adhesively coupled to the chassis with a first portion of adhesive, and a detection or transmission module optically aligned with the optical lens assembly so that a path of a laser beam emitted from a laser module of the transmission module is oriented with an optical path in the optical lens assembly to a detection sensor of the detection module. The detection and/or transmission module may be coupled to the chassis with a second portion of adhesive between the transparent mounting block and detection or transmission module. The transparent mounting block allows visual inspection of the first and second portions of adhesive through the transparent mounting block.

In some embodiments, the system includes a detection module including a detection circuit board assembly including a board and the detection sensor, and a bracket. The detection circuit board assembly may be fixedly coupled to the bracket with screws. the second portion of adhesive may be between the transparent mounting block and the bracket. The bracket may include a planar portion and a tab extending away from the planar portion. A first bonding surface of the transparent mounting block may be positioned against the tab with the second portion of adhesive there between.

In some embodiments, the system includes a transmission module including a transmission circuit board assembly comprising a board and the laser module, and a second chassis. The transmission circuit board assembly may be fixedly coupled to the second chassis with screws. The second portion of adhesive may be between the transparent mounting block and the second chassis. The second chassis may include a central portion to which the transmission circuit board assembly is fixedly coupled and a tab extending away from the central portion. A first bonding surface of the transparent mounting block may be positioned against the tab with the second portion of adhesive there between.

In some embodiments, the transparent mounting block allows the first and second portions of adhesive to be curable via ultraviolet radiation emitted through the transparent mounting block. The transparent mounting block may be made of glass. The transparent mounting block may have a rectangular prism shaped body. The rectangular prism shaped body may define a first bonding surface with a first surface roughness, and a second surface opposite the first bonding surface and with a second surface roughness less than the first surface roughness. The first portion of adhesive may be positioned between the first bonding surface and the chassis. The first surface roughness of the first bonding surface may be defined by a plurality of grooves.

### BRIEF DESCRIPTION OF THE DRAWINGS

The features of the various embodiments described above, as well as other features and advantages of certain embodiments of the present invention will be more apparent from the following detailed description taken in conjunction with the accompanying drawings, in which:

FIGS. 1A and 1B show a module of an autonomous vehicle LiDAR assembly including a chassis, a detection module, a transmission module, and transparent mounting blocks, according to certain embodiments;

FIGS. 2A-D shows transparent mounting blocks, according to certain embodiments;

FIGS. 3A-3C shows a detection module and components thereof, according to certain embodiments;

FIGS. 4A and 4B shows a transmission module and components thereof, according to certain embodiments;

FIGS. 5A-5D; show steps of optically aligning, and adhesively coupling a detection module to a chassis using transparent mounting blocks, according to certain embodiments.

FIGS. 6A-6C; show steps of optically aligning, and adhesively coupling a transmission module to a chassis using transparent mounting blocks, according to certain embodiments.

Throughout the drawings, it should be noted that like reference numbers are typically used to depict the same or similar elements, features, and structures.

### DETAILED DESCRIPTION

Aspects of the present disclosure relate generally to optical alignment and improved adhesive bonding for coupling a detection module and/or transmission module to a chassis. The detection module and transmission module are optically aligned relative to an optical lens assembly and secured to a chassis with transparent mounting blocks adhesively bonded to the chassis and bonding surfaces of the detection module and transmission module. The chassis, detection module, transmission module, and optical lens assembly may be part of a LiDAR assembly, according to certain embodiments.

In the following description, various examples of improved adhesive bonding for coupling a detection module and a transmission module to a chassis are described. For purposes of explanation, specific configurations and details are set forth in order to provide a thorough understanding of the embodiments. However, it will be apparent to one skilled in the art that certain embodiments may be practiced or implemented without every detail disclosed. Furthermore, well-known features may be omitted or simplified in order to prevent any obfuscation of the novel features described herein.

The following high-level summary is intended to provide a basic understanding of some of the novel innovations depicted in the Figures and presented in the corresponding descriptions provided below.

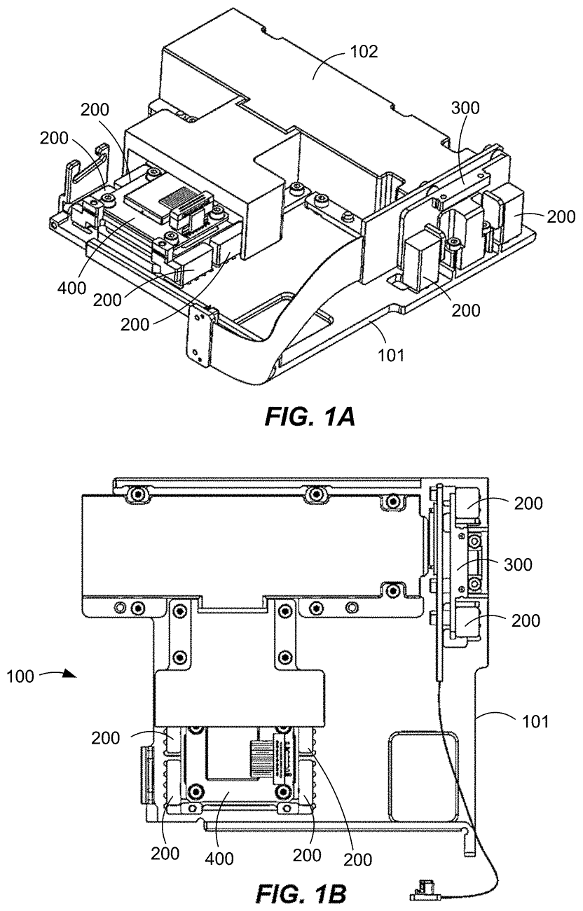

Generally, aspects of the technology are directed to implementations of fixedly coupling a detection module and/or a transmission module to a chassis so that the respective module is optically aligned with an optical lens assembly, also coupled to the chassis. For example, a Light Detection and Ranging (LiDAR) assembly of an autonomous vehicle may include a detection module, also referred to as a receiving module (RX), and a transmission module (TX), or a combination transmission and receiving module (TX/RX). The detection module comprises a detection circuit board assembly coupled to a bracket, for example a shown in FIG. 1A. A laser beam emitted from a transmission module is directed through an optical path of an optical lens assembly, reflected off of an objection and returns through the optical lens assembly to a detection sensor on the detection circuit board assembly. Due to the precision needed for the LiDAR to accurately perform measurements, it is important for the optical alignment of the detection and transmission modules to be precise and maintained during extended periods of use of the LiDAR. The disclosed transparent mounting blocks allow for complete curing and visual inspection of adhesives used to couple the transmission and detection modules to the chassis in order to verify that a uniform layer of adhesive is present. A uniform layer of adhesive is beneficial under high temperature operating conditions which may lead to degradation and/or expansion of the adhesive which is more likely to lead to misalignment when the adhesive is not uniform and/or is not properly cured.

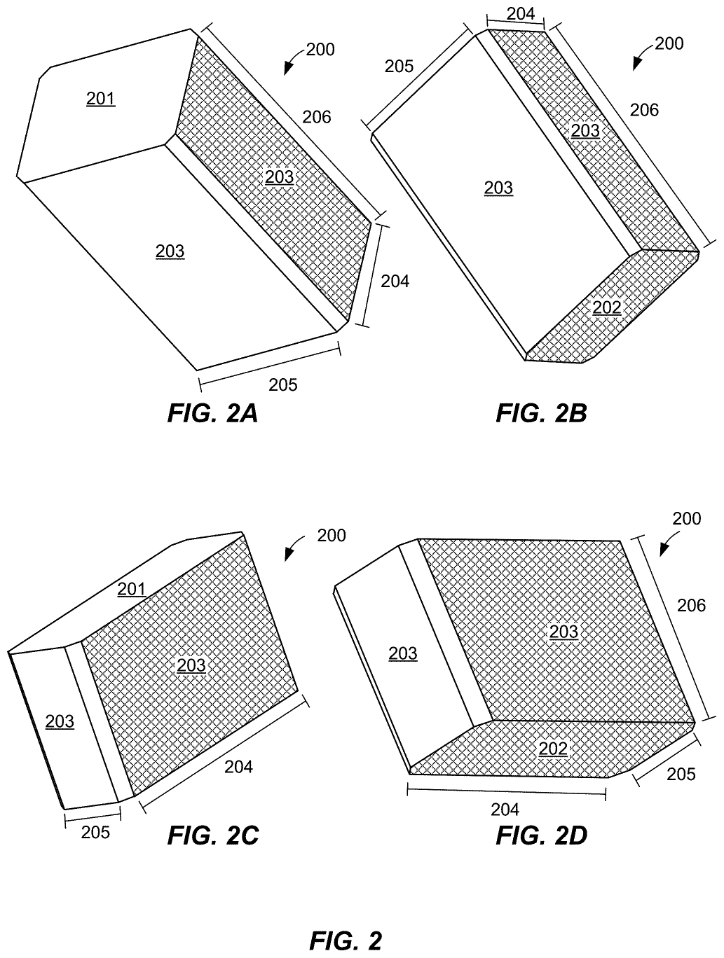

Specifically, the present technology relates to the use of a transparent mounting block, as shown in FIGS. 2A-2D, which are used to adhesively couple to both the chassis and detection and/or transmission modules, in order to fixedly couple the detection and/or transmission modules to the chassis in an optically aligned orientation. The Figures are further described in greater detail below and the scope of the various embodiments of the present invention is not limited by this summary, which merely operates to present a high-level understanding of some of the novel concepts that follow.

FIG. 1A shows a portion of a TX/RX module 100 of an autonomous vehicle LiDAR assembly. In some embodiments, the present technology may be directed to a TX module and/or a separate RX module. As shown, the TX/RX module 100 comprises a chassis 101, an optical lens assembly 102, a plurality of transparent mounting blocks 200, a detection module 300, and a transmissions module 400. In use, a laser beam is emitted from the transmission module 400 and directed through an optical path of the optical lens assembly 102, emitted into the surrounding environment from the TX/RX module 100, reflected off of an object in the surrounding environment, returned to the TX/RX module 100 through the optical lens assembly 102 to a detection sensor of the detection module 300.

The transparent mounting blocks 200 are adhesively coupled to the chassis 101, and also adhesively coupled to the detection module 300 and transmission module 400. In embodiments, no fasteners are used to secure the detection module 300 and transmission module 400 to the chassis 101, and the detection module 300 and transmission module 400 are solely coupled to the chassis 101 with adhesive via the transparent mounting blocks 200.

FIGS. 2A and 2B show a first embodiment of a transparent mounting block 200, and FIGS. 2C and 2D show a second embodiment of a transparent mounting block 200. As shown, the transparent mounting block 200 may be in the shape of a rectangular prism and define a top surface 201, a bottom surface 202, and a plurality of side surfaces 203. In some embodiment, for example as shown in FIGS. 2A and 2B, the height 206 may be larger than the length 205 and width 204, and in some embodiments, for example as shown in FIGS. 2C and 2D the width 204 may be greater than the height 206 and length 205. The dimensions may be selected based on the dimensions of the module to be coupled to the chassis 101 and the amount of available surfaces to bond to on the chassis. In embodiments, the transparent mounting blocks 200 may be other shapes including perpendicular faces, for example a triangular prism.

The transparent mounting blocks 200 define bonding surfaces and inspection surfaces. The bonding surfaces may include characteristics for increasing adhesive bond strength relative to a polished surface. The inspection surfaces, may be polished surfaces providing an optically clear imaging path to visually inspect the bonding surfaces through the body of the transparent mounting block 200. For example, the bonding surface and underlying adhesive may be inspector by a person or via a camera. In embodiments, the surface roughness of a bonding surface of the transparent mounting block is greater than the surface roughness of an inspection surface.

In embodiments, the transparent mounting block 200 may be formed of glass, for example borosilicate glass such as BK7. In embodiments, the increased surface roughness of the bonding surfaces is formed via machining, chemical etching and/or mechanical etching. In embodiments, the increased surface roughness may be defined by a plurality of grooves on the bonding surface.

In FIGS. 2A-2D, surfaces including cross-hatching represent surfaces having a greater surface roughness than surfaces without cross-hatching. As shown, the bottom surface 202 of the transparent mounting block 200 may have an increased surface roughness and therefore define a bonding surface. Further, as shown, one of the side surfaces 203 also may have an increased surface roughness and therefore also defines a bonding surface. In the figures, the entire faces of the transparent mounting block are indicated as including increased surface roughness, however in embodiments, increased surface roughness may only be included on a sub-portion of a surface.

The bottom surface 202, which is a bonding surface, and which may be referred to as a first bonding surface, may be adhesively coupled to the chassis 101, and the one or more side surfaces 203 defining bonding surfaces may be adhesively coupled to the detection module 300 or transmission module 400.

As shown in FIGS. 2A-2D some of the surfaces, for example the top surface 201 and some of the side surfaces 203 are not bonding surfaces and define inspection surfaces, as noted above. In addition to allowing for the visual inspection of the bonding surfaces and underlying adhesives, the inspection surfaces may be used to cure adhesives in the form of UV epoxies. Specifically, UV radiation may be passed through the inspection surfaces, through the body of the transparent mounting block 200, and to the bonding surfaces, where the UV radiation may cure the adhesive underlying the bonding surfaces. This curing process is beneficial compared to a non-transparent mounting block wherein it would not be possible to deliver UV radiation to the adhesive between the middle of the bonding surfaces and the chassis. Accordingly, the transparent mounting blocks 200 allow for complete curing of the UV epoxies.

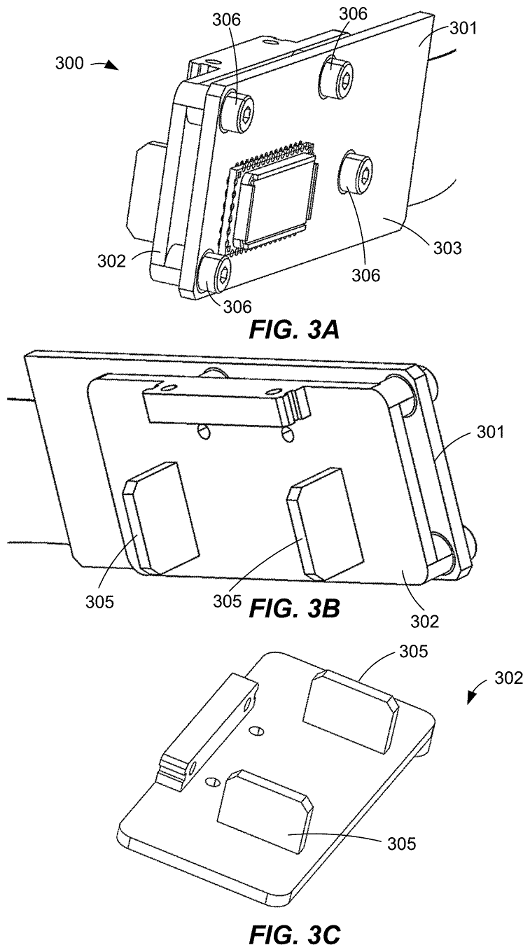

FIGS. 3A-3C show an embodiment of a detection module 300. The detection module 300 comprises a detection circuit board assembly 301 coupled to a bracket 302. The detection circuit board assembly 301 may be coupled to the bracket 302 with fasteners, for example screws 306 As shown the detection circuit board assembly 301 comprises a board 303, for example a printed circuit board (PCB) comprising a plastic reinforced board with conductive traces. The detection circuit board assembly 301 further comprises circuitry components coupled to the board 303, for example a detection sensor 304. In embodiments, the board 303 may be populated with any configuration of circuitry components. The detection circuit board assembly 301 may comprise wiring/cabling coupled to other components of the TX/RX module 100 for transferring electrical signals to and from the detection circuit board assembly 301 and other components of the LiDAR system.

FIG. 3C shows an embodiment of a bracket 302. The bracket 302 may also be referred to as a chassis. For example, as used herein, the chassis 101 may be referred to as a chassis or a first chassis, and the bracket 302 may be referred to as a chassis or a second chassis, or vice versa. As shown in FIG. 3C, the bracket 302 may have a generally planar and rectangular body corresponding to the shape and size of the board 303. The bracket 302 defines a front side facing the PCB and a backside facing the opposite direction. The backside includes two tabs 305 extending from the planar body of the bracket 302. The tabs 305 may be used for adhesively coupling the detection module 300 to the transparent mounting blocks 200. For example, a transparent mounting block 200 may be translated along the chassis 101 so that a side surface 203, which is a bonding surface, is placed against the tab 305 with adhesive between the tab 305 and the transparent mounting block 200. In some embodiments, the tabs 305 may include increased surface roughness to improve adhesive bonding strength.

The bracket 302 may be solid and formed monolithically, for example molded and/or machined from a single piece of material. In embodiments, the bracket 302 is comprised of a metal with a high thermal conductivity, for example aluminum, copper and/or steel. Solid monolithically formed metal brackets 302 are advantageous in conducting thermal energy compared to hollow, webbed, multi-component and/or non-metal constructions.

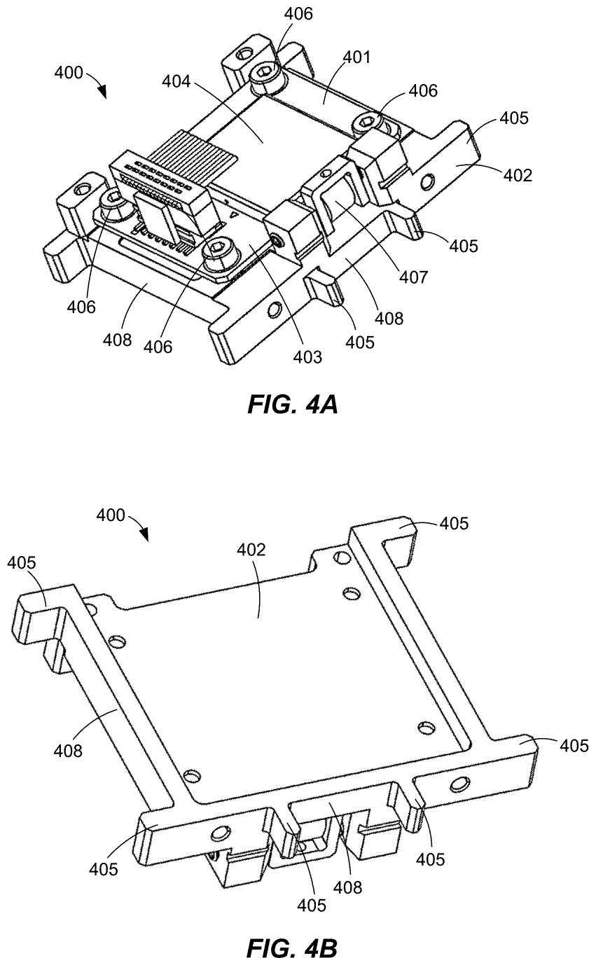

FIGS. 4A and 4B show an embodiment of a transmission module 400. The transmission module 400 300 comprises a transmission circuit board assembly 401 coupled to a chassis 402. The transmission circuit board assembly 401 may be coupled to the chassis 402 with fasteners, for example screws 406 As shown the transmission circuit board assembly 401 comprises a board 403, for example a printed circuit board (PCB) comprising a plastic reinforced board with conductive traces. The transmission circuit board assembly 401 further comprises circuitry components coupled to the board 403, for example a laser 404 and lens 407. In embodiments, the board 403 may be populated with any configuration of circuitry components. The transmission circuit board assembly 401 may comprise wiring/cabling coupled to other components of the TX/RX module 100 for transferring electrical signals to and from the transmission circuit board assembly 401 and other components of the LiDAR system.

As shown in FIGS. 4A and 4B, the chassis 402 may have a generally rectangular body corresponding to the shape and size of the board 403. The chassis 402 defines a top side facing the PCB and a bottom side facing the opposite direction, with a sidewall there between. The bottom side is positioned over and faces the chassis 101 as shown in FIG. 1A. The chassis 402 further includes a plurality of tabs 405 extending from the sidewall of the chassis 402. The tabs 405 and/or sidewall 408 may be used for adhesively coupling the transmission module 400 to the transparent mounting blocks 200. For example, a transparent mounting block 200 may be translated along the chassis 101 so that a side surface 203, which is a bonding surface, is placed against the tab 405 and/or sidewall 408 with adhesive between the tab 405 and the transparent mounting block 200. In some embodiments, the tabs 405 and/or sidewalls 408 may include increased surface roughness to improve adhesive bonding strength.

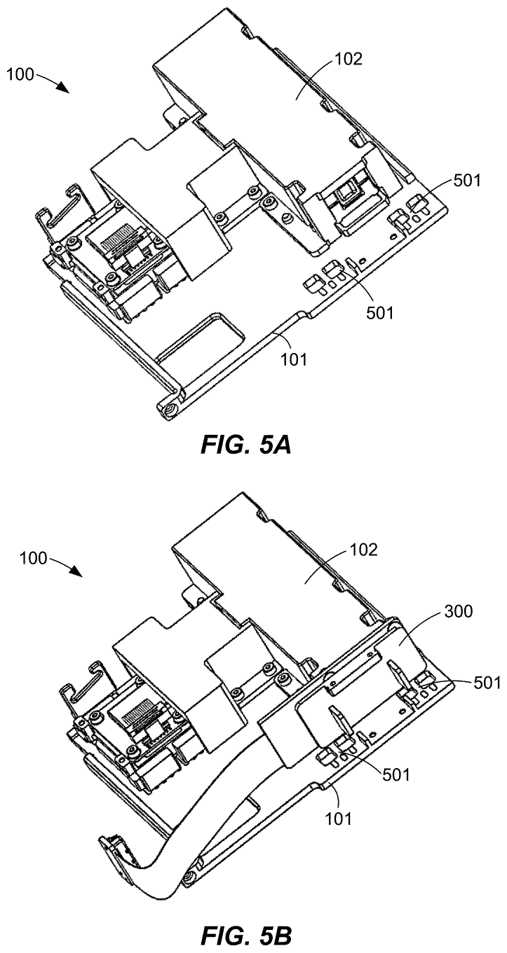

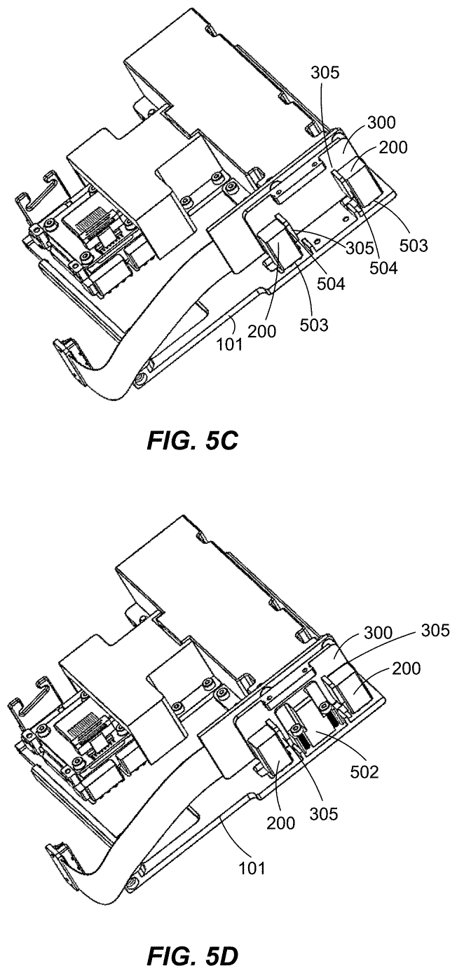

FIGS. 5A-5D show steps of an embodiment of optically aligning, and fixedly coupling, with transparent mounting blocks 200, a detection module 300 relative to a chassis 101 of a TX/RX module 100 of a LiDAR assembly. As shown in FIG. 5A, the chassis 101 may define RX bonding surfaces 501 for receiving the bottom surface 202, a bonding surface, of the transparent mounting block 200. The RX bonding surfaces 501 may be larger than the bottom surface 202 of the transparent mounting block 200 in order to allow for the transparent mounting block 200 to be positioned at a plurality of locations and orientations. The RX bonding surface 501 of the chassis 101 may be planar, and may be smooth or may include texture for improving adhesive bonding strength.

As shown in FIG. 5B, the detection module 300 may be positioned proximate to the RX bonding surfaces 501 of the chassis 101 and optically aligned with the optical lens assembly 102 with the detection circuit board assembly 301 facing toward the optical lens assembly. The detection module 300 may be positioned and aligned using an alignment jig.

To optically align the detection module 300 relative to the optical lens assembly 102, the detection module 300 may be manipulated about one or more of the six degrees of freedom, i.e. xyz translation and xyz rotation, and an output beam emitted from the transmission module 400 through the optical lens assembly 102 may be received by the detection sensor 304 to determine that the detection module 300, and therefore detection sensor 304, is in an optically aligned orientation.

With the detection module 300 held in place with an alignment jig and optically aligned as shown in FIG. 5B, first portions of adhesive 503 may be applied to the RX bonding surfaces 501 and/or the bottom surfaces 202 of the transparent mounting blocks 200, and the transparent mounting blocks 200 may be positioned on the chassis 101 as shown in FIG. 5C. As shown, the bottom surfaces 202 of the transparent mounting blocks 200 are positioned over the RX bonding surfaces 501. The transparent mounting blocks 200 may each be translated so that the side bonding surfaces, which also may be referred to as first and/or second bonding surfaces, are positioned against the tabs 305 of the detection module 300. A second portion of adhesive 504 may be applied to the tabs 305 and/or side surface 203, a bonding surface, prior, during, and/or after the steps shown in FIGS. 5A-5C.

With the detection module 300 held in place with an alignment jig and the transparent mounting blocks 200 positioned with adhesive between the transparent mounting blocks 200 and the chassis 101, and between the transparent mounting blocks 200 and the detection module 300, as shown in FIG. 5C, the adhesive may be cured. In embodiments, the adhesive may be a UV epoxy, and curing of the adhesive may be performed by emitting ultraviolet radiation through the transparent mounting block 200. The ultraviolet radiation may be directed into the transparent mounting block through an inspection surface, for example the 201 of a side surface 203, in order to irradiate and cure the first and second portions of adhesive.

In embodiments, due to the glass composition of the transparent mounting blocks 200, heat generated by the detection module 300 may not be adequately transferred to the chassis and a thermal management block may be mounted to the chassis 101, as shown in FIG. 5D. The use of thermal management blocks is disclosed in U.S. application Ser. No. 17/135,880, which is hereby incorporated by reference. As shown in FIG. 5D, the thermal management block 502 is positioned between the tabs 305 of the detection module 300, and may be fastened to the chassis 101 with screws. Thermal gel may be applied between the bracket 302 of the detection module 300 and the thermal management block 502 in order to maintain a high thermal conductivity thermal flow path between the detection module 300 and the chassis 101. In embodiments, the curing of the adhesive may be performed before or after securing the thermal management block and/or applying the thermal gel.

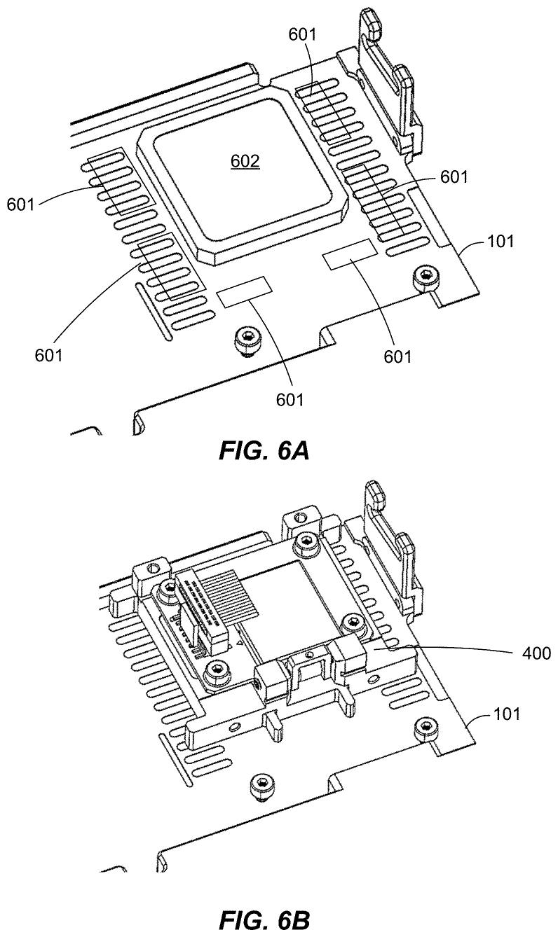

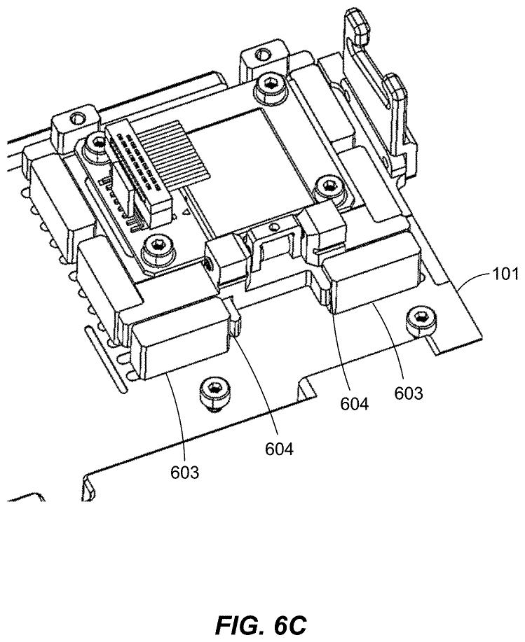

FIGS. 6A-6C show steps of an embodiment of optically aligning, and fixedly coupling, with transparent mounting blocks 200, a transmission module 400 relative to a chassis 101 of a TX/RX module 100 of a LiDAR assembly. As shown in FIG. 6A, the chassis 101 may define TX bonding surfaces 601 for receiving the bottom surface 202, a bonding surface, of the transparent mounting block 200. The TX bonding surfaces 601 may be larger than the bottom surface 202 of the transparent mounting block 200 in order to allow for the transparent mounting block 200 to be positioned at a plurality of locations and orientations. The TX bonding surface 601 of the chassis 101 may be planar, and may be smooth or may include texture for improving adhesive bonding strength.

As shown in FIGS. 6A and 6B, the transmission module 400 may be positioned onto a pedestal 602 of the chassis 101. Thermal gel may be applied between the pedestal and the transmission module 400. The transmission module 400 may be positioned and optically aligned using an alignment jig. To optically align the transmission module 400 relative to the optical lens assembly 102, the transmission module 400 may be manipulated about one or more of the six degrees of freedom, i.e. xyz translation and xyz rotation, and an output beam emitted from the transmission module 400 through the optical lens assembly 102 may be received by the detection sensor 304 to determine that the transmission module 40 is in an optically aligned orientation.

With the transmission module 400 held in place with an alignment jig and optically aligned as shown in FIG. 6B, first portions of adhesive 603 may be applied to the TX bonding surfaces 601 and/or the bottom surfaces 202 of the transparent mounting blocks 200, and the transparent mounting blocks 200 may be positioned on the chassis 101 as shown in FIG. 6C. As shown, the bottom surfaces 202 of the transparent mounting blocks 200 are positioned over the TX bonding surfaces 601. The transparent mounting blocks 200 may each be translated so that the side bonding surfaces, which also may be referred to as first and/or second bonding surfaces, are positioned against the tabs 405 and/or sidewalls 408 of the transmission module 400. A second portion of adhesive 604 may be applied to the tabs 405, sidewalls 408, and/or side surface 203, a bonding surface, prior, during, and/or after the steps shown in FIGS. 6A-6C.

With the transmission module 400 held in place with an alignment jig and the transparent mounting blocks 200 positioned with adhesive between the transparent mounting blocks 200 and the chassis 101, and between the transparent mounting blocks 200 and the transmission module 400, as shown in FIG. 6C, the adhesive may be cured. In embodiments, the adhesive may be a UV epoxy, and curing of the adhesive may be performed by emitting ultraviolet radiation through the transparent mounting block 200. The ultraviolet radiation may be directed into the transparent mounting block through an inspection surface, for example the 201 of a side surface 203, in order to irradiate and cure the first and second portions of adhesive.

Other variations are within the spirit of the present disclosure. Thus, while the disclosed techniques are susceptible to various modifications and alternative constructions, certain illustrated examples thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims. For instance, any of the examples, alternative examples, etc., and the concepts thereof may be applied to any other examples described and/or within the spirit and scope of the disclosure.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate examples of the disclosure and does not pose a limitation on the scope of the disclosure unless otherwise claimed. No language in the specification should be construed as indicating any non-claimed element as essential to the practice of the disclosure.

What is claimed is:

1. A method of optically aligning a detection or transmission module with an optical lens assembly in a LiDAR system, wherein the optical lens assembly is coupled to a chassis, the method comprising:
orienting the detection or transmission module relative to the optical lens assembly to an optically aligned orientation wherein a path of a laser beam emitted from a laser module of the transmission module is oriented with an optical path in the optical lens assembly to a detection sensor of the detection module;
applying a first portion of adhesive between a transparent mounting block and the chassis;
applying a second portion of adhesive between the transparent mounting block and the detection or transmission module;
translating the transparent mounting block adjacent to the oriented detection or transmission module; and
curing the first and second portions of adhesive in order to fixedly couple the detection or transmission module relative to the chassis,
wherein the transparent mounting block is configured to allow visual inspection of the cured first and second portions of adhesive through the transparent mounting block.

2. The method of claim 1, wherein the detection or transmission module comprises a detection module,
wherein the detection module comprises a detection circuit board assembly comprising a board and the detection sensor, and a bracket,
wherein the detection circuit board assembly is fixedly coupled to the bracket with screws, and
wherein applying the second portion of adhesive between the transparent mounting block and the detection or transmission module comprises applying the second portion of adhesive between the transparent mounting block and the bracket.

3. The method of claim 2, wherein the bracket comprises a planar portion and a tab extending away from the planar portion,
wherein translating the transparent mounting block adjacent to the oriented detection or transmission module comprises positioning a first bonding surface of the transparent mounting block against the tab with the second portion of adhesive there between.

4. The method of claim 1, wherein the detection or transmission module comprises a transmission module,
wherein the transmission module comprises a transmission circuit board assembly comprising a board and the laser module, and a second chassis,
wherein the transmission circuit board assembly is fixedly coupled to the second chassis with screws, and
wherein applying the second portion of adhesive between the transparent mounting block and the detection or transmission module comprises applying the second portion of adhesive between the transparent mounting block and the second chassis.

5. The method of claim 4, wherein the second chassis comprises a central portion to which the transmission circuit board assembly is fixedly coupled and a tab extending away from the central portion,
wherein translating the transparent mounting block adjacent to the oriented detection or transmission module comprises positioning a first bonding surface of the transparent mounting block against the tab with the second portion of adhesive there between.

6. The method of claim 1, wherein curing the first and second portions of adhesive in order to fixedly couple the detection or transmission module relative to the chassis comprises emitting ultraviolet radiation through the transparent mounting block in order to cure the first and second portions of adhesive.

7. The method of claim 1, wherein the transparent mounting block is comprised of glass.

8. The method of claim 1, wherein the transparent mounting block comprises a rectangular prism shaped body.

9. The method of claim 8, wherein the rectangular prism shaped body defines a first bonding surface with a first surface roughness, and a second face opposite the first bonding surface with a second surface roughness less than the first surface roughness,
wherein the first portion of adhesive is applied between the first bonding surface and the chassis.

10. The method of claim 9, wherein the first surface roughness of the first face is defined by a plurality of grooves.

11. A LiDAR system, comprising:
a chassis;
an optical lens assembly coupled to a chassis,
a transparent mounting block adhesively coupled to the chassis with a first portion of adhesive; and
a detection or transmission module configured to be optically aligned with the optical lens assembly so that a path of a laser beam emitted from a laser module of the transmission module is oriented with an optical path in the optical lens assembly to a detection sensor of the detection module;
wherein the detection or transmission module is coupled to the chassis with a second portion of adhesive between the transparent mounting block and detection or transmission module, and
wherein the transparent mounting block is configured to allow visual inspection of the first and second portions of adhesive through the transparent mounting block.

12. The system of claim 11, wherein the detection or transmission module comprises a detection module,
wherein the detection module comprises a detection circuit board assembly comprising a board and the detection sensor, and a bracket,
wherein the detection circuit board assembly is fixedly coupled to the bracket with screws, and
wherein the second portion of adhesive is between the transparent mounting block and the bracket.

13. The system of claim 12, wherein the bracket comprises a planar portion and a tab extending away from the planar portion,
wherein a first bonding surface of the transparent mounting block is positioned against the tab with the second portion of adhesive there between.

14. The system of claim 11, wherein the detection or transmission module comprises a transmission module,
wherein the transmission module comprises a transmission circuit board assembly comprising a board and the laser module, and a second chassis,
wherein the transmission circuit board assembly is fixedly coupled to the second chassis with screws, and
wherein the second portion of adhesive is between the transparent mounting block and the second chassis.

15. The system of claim 14, wherein the second chassis comprises a central portion to which the transmission circuit board assembly is fixedly coupled and a tab extending away from the central portion,
wherein a first bonding surface of the transparent mounting block is positioned against the tab with the second portion of adhesive there between.

16. The system of claim 11, wherein the transparent mounting block is configured to that the first and second portions of adhesive are curable via ultraviolet radiation emitted through the transparent mounting block.

17. The system of claim 11, wherein the transparent mounting block is comprised of glass.

18. The system of claim 11, wherein the transparent mounting block comprises a rectangular prism shaped body.

19. The system of claim 18, wherein the rectangular prism shaped body defines a first bonding surface with a first surface roughness, and a second surface opposite the first bonding surface and with a second surface roughness less than the first surface roughness,
wherein the first portion of adhesive is positioned between the first bonding surface and the chassis.

20. The system of claim 19, wherein the first surface roughness of the first bonding surface is defined by a plurality of grooves.
